(19) United States
(12) Patent Application Publication
(10) Pub. No.: US 2010/0263133 A1
(43) Pub. Date: Oct. 21, 2010

(54) MULTI-PURPOSE TOOL

(76) Inventor: Timothy Langan, Laguna Hills, CA (US)

Correspondence Address: JAFARI LAW GROUP, P.C., 801 N. PARKCENTER DRIVE, SUITE 220, SANTA ANA, CA, 92705, US

(21) Appl. No.: 12/427,701

(22) Filed: Apr. 21, 2009

(51) Int. Cl. B25D 1/00; B25F 1/02; A01B 1/02; B26B 23/00

(52) U.S. Cl. 7/143; 7/167; 294/49; 30/308.1

(57) ABSTRACT

The invention is a multi-purpose tool that may provide the utility of a plurality of tools at a reduced weight and volume through the interchangeability of distinct tool attachments. A multi-purpose tool may comprise an elongated member including a handle and a plurality of universal connectors, wherein each universal connector is adapted to securely attach to a plurality of distinct tools, a first distinct tool including a first universal connector securely mated to one of the universal connectors of the elongated member, and a second distinct tool including a second universal connector securely mated to another of the universal connectors of the elongated member. A plurality of tool attachments may be attached to and removed from the elongated member in order to provide a specific utility.

### TECHNICAL FIELD OF THE INVENTION

The present invention relates in general to a tool, and more specifically, to a multi-purpose tool that may provide the utility of a plurality of tools through the interchangeability of distinct tool attachments.

### COPYRIGHT & TRADEMARK NOTICE

A portion of the disclosure of this patent application may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### BACKGROUND OF THE INVENTION

For millennia, people have used tools to perform manual or mechanical tasks. Tools can make many of the most laborious of tasks effortless and simple. Without an axe or other similar tool, slicing a log would prove to be very difficult. Therefore, it is of no surprise that most people will opt to use a tool when faced with a mechanical activity.

Shovels, hammers, and picks, to name a few different tools, all provide a valuable utility. Each tool, however, may provide a unique utility that other tools cannot. While a shovel is designed to allow a user to dig more easily, the shovel would provide little help in boring a hole through wood. Thus, the more tools one has available to them, the higher the utility one may have at his or her disposal.

While each tool may provide a unique utility, each tool may have its own unique dimensions and weight. Should one be faced with limited storage space or carrying capacity, such as military personnel, a rock climber, or a person on a camping trip, then they would be limited as to the type and number of tools they may bring along. In such a situation, the utility one would have at his or her disposal would be dependent upon their storage space or carrying capacity.

In a situation where one is faced with a limited storage space or carrying capacity, it would be advantageous for a tool to provide increased utility at a lower volume and weight cost. Thus, there is a need for a multi-purpose tool. Specifically, there is a need for a device that may provide the utility of a plurality of tools through the interchangeability of distinct tool attachments. It is to these ends that the present invention has been developed.

### SUMMARY OF THE INVENTION

To minimize the limitations in the prior art, and to minimize other limitations that will be apparent upon reading and understanding the present specification, the present invention describes a multi-purpose tool, comprising an elongated member including a handle and a plurality of universal connectors, wherein each universal connector is adapted to securely attach to a plurality of distinct tools, a first distinct tool including a first universal connector securely mated to one of the universal connectors of the elongated member, and a second distinct tool including a second universal connector securely mated to another of the universal connectors of the elongated member.

An apparatus in accordance with the present invention may also comprise an elongated member including a handle and a plurality of universal connectors, wherein each universal connector is adapted to securely attach to a plurality of distinct tools.

Distinct tools in accordance with the present invention may include, among others, a pick, hammer, nail remover, knife, hook, screwdriver, helmet counterweight, shovel, axe, spike, scissors, or a crowbar.

It is an objective of the present invention to provide the utility of a plurality of tools with one device.

It is another objective of the present invention to provide a plurality of distinct tool accessories, wherein each may securely be attached to and removed from the multi-purpose tool.

Finally, it is yet another objective of the present invention to provide the utility of a plurality of tools at a reduced cost of weight and volume.

These and other advantages and features of the present invention are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1(a) illustrates a perspective view of a multi-purpose tool comprising a spike and a hammer and pick combination.

FIG. 1(b) illustrates a perspective view of another multi-purpose tool comprising a shovel and an axe.

FIG. 2 illustrates a side view of a multi-purpose tool comprising a hammer and pick combination, a spike and a knife.

FIG. 3 illustrates a side view of a multi-purpose tool comprising four distinct tools.

FIG. 4 illustrates a perspective view of a multi-purpose tool comprising four distinct tools.

### DETAILED DESCRIPTION OF THE DRAWINGS

In the following discussion that addresses a number of embodiments and applications of the present invention, reference is made to the accompanying drawings that form a part hereof, where depictions are made, by way of illustration, of specific embodiments in which the invention may be practiced. It is to be understood that other embodiments may be utilized and changes may be made without departing from the scope of the present invention.

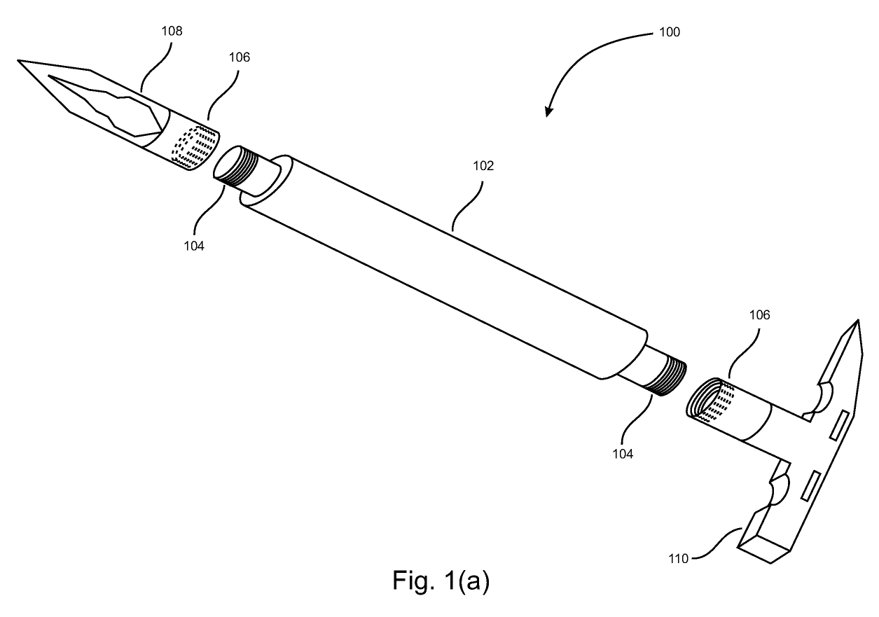

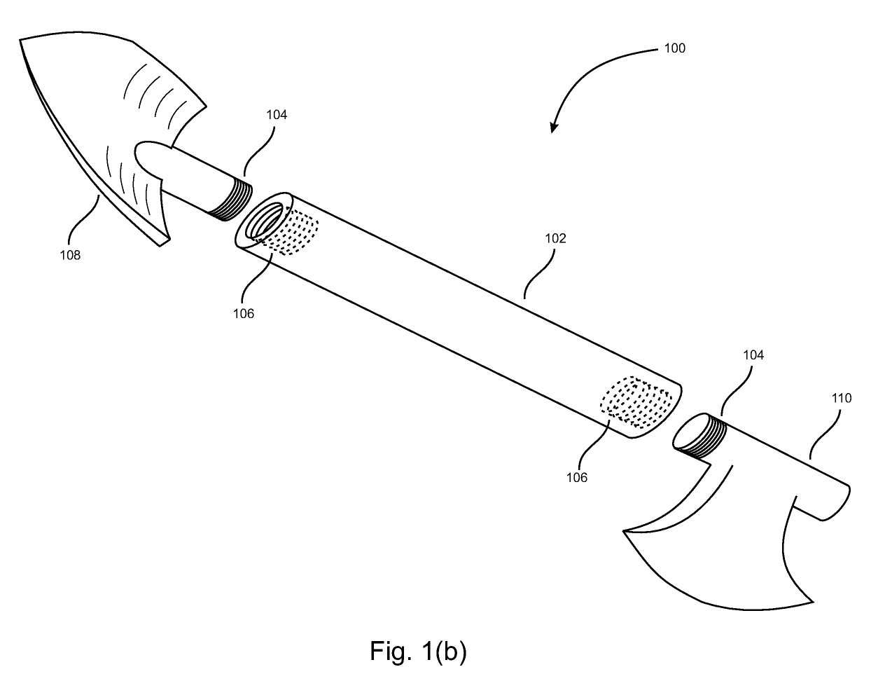

FIG. 1(a) illustrates a perspective view of a multi-purpose tool comprising a spike and a hammer and pick combination tool. FIG. 1(b) illustrates a perspective view of another multi-purpose tool comprising a shovel and an axe.

FIGS. 1(a) and 1(b) show multi-purpose tool 100, which comprises elongated member 102, universal connector 104, universal receiver 106, first distinct tool 108, and second distinct tool 110. Multi-purpose tool 100 is designed to provide the utility of a plurality of tools, but to also be comprised of a reduced weight and volume through the interchangeability of distinct tool attachments.

Elongated member 102 is the main body of multi-purpose tool 100. Elongated member 102 may be composed of a variety of materials, including wood, metals, alloys, plastics, or any other material that is sufficiently rigid so as to withstand normal wear and tear during use of multi-purpose tool 100. Additionally, elongated member 102 may be lightweight so as to reduce burden during use, storage or transport.

Elongated member 102 may be cylindrical or rectangular in shape, such that a user may securely, but comfortably, grip elongated member 102 in use or transport of multi-purpose tool 100. Additionally, the exterior surface of elongated member 102 may comprise a texture that would facilitate better grip of multi-purpose tool 100 by a user. In an exemplary embodiment, elongated member 102 may be a cylindrical rod, with a length between two and three feet. However, the shape or dimensions of elongated member 102 should not be interpreted so as to limit the scope of the present invention.

Universal connector 104 and universal receiver 106 are components of multi-purpose tool 100 designed to connect elongated member 102 to a plurality of distinct tools. Universal connector 104 and universal receiver 106 are designed to securely couple, attaching elongated member 102 to a distinct tool. However, universal connector 104 and universal receiver 106, when connected, may be disengaged so as to disconnect elongated member 102 from a distinct tool.

In the present embodiment, universal connector 104 may comprise a male-type component with threading. Universal receiver 106 may comprise a female-type component with corresponding threading to universal connector 104. In such an embodiment, universal connector 104 may securely couple with universal receiver 106 via a screw mechanism, wherein universal connector 104 may screw into universal receiver 106 via their corresponding threading.

In another embodiment of the present invention, universal connector 104 and universal receiver 106 may couple via a clamping mechanism. In such an embodiment, universal connector 104 may be received by universal receiver 106, which may securely couple to universal connector 104 via a clamp. In other embodiments of the present invention, however, universal connector 104 and universal receiver 106 may couple via other mechanisms, such as magnetism, a collet, snapping joints, or other different mechanical means of connection.

In the embodiment of the present invention depicted in FIG. 1(a), universal connectors 104 are situated at distal and proximal ends of elongated member 102, and universal receivers 106 are situated at the ends of a first distinct tool 108 and a second distinct tool 110, respectively. However, in another embodiment of the present invention as depicted in FIG. 1(b), universal receivers 106 may be situated at distal and proximal ends of elongated member 102, and universal connectors 104 may be situated at the ends of a first distinct tool 108 and a second distinct tool 110, respectively. Thus, the placement or locations of universal connectors 104 and universal receivers 106, with respect to multi-purpose tool 100, should not be interpreted so as to limit to scope of the present invention.

First distinct tool 108 is a tool accessory for multi-purpose tool 100 that may be securely attached to and removed from elongated member 102 via universal connector 104 and universal receiver 106. In the embodiment of the present invention as depicted in FIG. 1(a), first distinct tool 108 comprises a spike tool. However, first distinct tool 108 may comprise a shovel, as depicted in FIG. 1(b). Additionally, in other embodiments of the present invention, first distinct tool 108 may comprise another tool such as a hammer, pick, nail remover, axe, crowbar, helmet counterweight or other device or combination thereof.

Helmet counterweight is a device that may be used by law enforcement or military personnel to counterbalance the weight of a night vision goggle unit upon the front of a user's helmet. In one embodiment, a helmet counterweight may be attached to or removed from a helmet via hook and loop connectors or other method. In a preferred embodiment, the helmet counterweight may be designed such that each edge of helmet counterweight may provide the user with a different function. For example, one edge may be sharp enough such that helmet counterweight may be engaged as an axe, while one edge may be curved such that helmet counterweight may be engaged as a pick. Various embodiments of helmet counterweight may comprise a shovel, an axe, an awl, pry, or a pick.

Second distinct tool 110 is a tool accessory for multi-purpose tool 100 that may be securely attached to and removed from elongated member 102 via universal connector 104 and universal receiver 106. In the embodiment of the present invention as depicted in FIG. 1(a), second distinct tool 110 comprises a hammer and pick combination tool. However, second distinct tool 110 may comprise an axe, as depicted in FIG. 1(b). Further, in other embodiments of the present invention, second distinct tool 110 may comprise a spike, nail remover, shovel, crowbar, helmet counterweight, or other like device or combination.

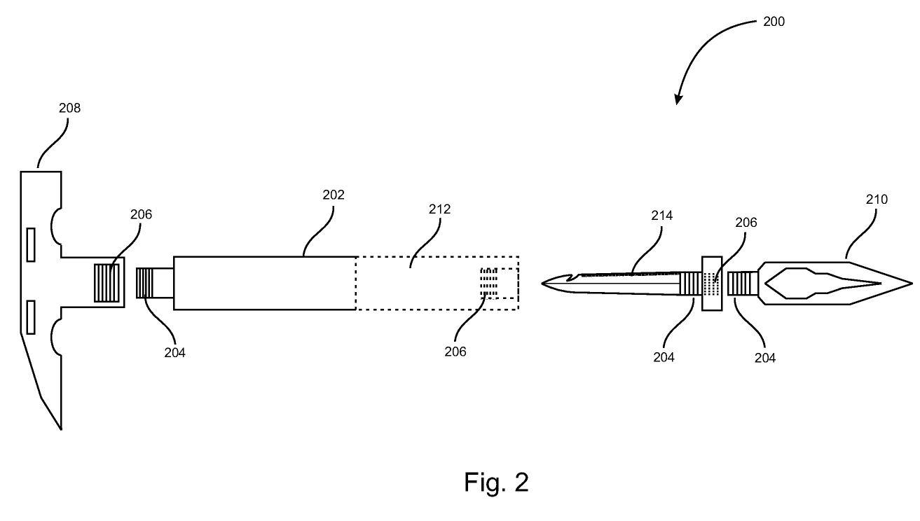

FIG. 2 illustrates a side view of a multi-purpose tool comprising a hammer and pick combination, a spike and a knife. FIG. 2 shows multi-purpose tool 200, which comprises elongated member 202, universal connector 204, universal receiver 206, first distinct tool 208, second distinct tool 210, interior region 212, and third distinct tool 214. Multi-purpose tool 200 is designed to provide the utility of a plurality of tools, but to also be comprised of a reduced weight and volume through the interchangeability of distinct tool attachments.

Elongated member 202 is the main body of multi-purpose tool 200. Elongated member 202 may be composed of a variety of materials, including wood, metals, alloys, plastics, or any other material that is sufficiently rigid so as to withstand normal wear and tear during use of multi-purpose tool 200. Elongated member 202 may be cylindrical or rectangular, such that a user may securely, but comfortably, grip elongated member 202 in use or transport of multi-purpose tool 200. Additionally, the exterior surface of elongated member 202 may comprise a texture that would facilitate better grip of multi-purpose tool 200 by a user. In a preferred embodiment, elongated member 202 may be a cylindrical rod, with a length between two and three feet.

Elongated member 202 may include interior region 212. Interior region 212 is a component of multi-purpose tool 200 designed to receive third distinct tool 214. In an exemplary embodiment of the present invention, the entire length of elongated member 202 may be hollow, comprising interior region 212. In such an embodiment, the length of interior region 212 may be equal to the length of elongated member 202. In other embodiments of the present invention, however, the length of interior region 212 may be less than that of elongated member 202. In such an embodiment, elongated member 202 may comprise both an interior region 212 and a solid, non-hollow region.

Universal connector 204 and universal receiver 206 are components of multi-purpose tool 200 designed to connect elongated member 202 to a plurality of distinct tools. Universal connector 204 and universal receiver 206 are designed to securely couple, attaching elongated member 202 to a distinct tool. Universal connector 204 and universal receiver 206 may also be disengaged so as to disconnect elongated member 202 from a distinct tool.

In the present embodiment, universal connector 204 may securely couple with universal receiver 206 via a screw mechanism, wherein universal connector 204 may screw into universal receiver 206 via their corresponding threading. In another embodiment of the present invention, however, universal connector 204 and universal receiver 206 may couple via other mechanisms, such as clamping, magnetism, a collet, snapping joints, or other different mechanical means of connection.

First distinct tool 208 is a tool accessory for multi-purpose tool 200 that may be securely attached to and removed from elongated member 202 via universal connector 204 and universal receiver 206. In the embodiment depicted in FIG. 2, first distinct tool 208 may comprise a hammer and pick combination. However, in other embodiments of the present invention, first distinct tool 208 may comprise another tool such as a spike, shovel, nail remover, axe, crowbar, helmet counterweight, knife or other device or combination thereof.

Second distinct tool 210 is a tool accessory for multi-purpose tool 200 that may be securely attached to and removed from elongated member 202 via universal connector 204 and universal receiver 206. In the embodiment depicted in FIG. 2, second distinct tool 210 comprises a spike tool. However, in other embodiments of the present invention, second distinct tool 210 may comprise a hammer, pick, axe, nail remover, shovel, crowbar, helmet counterweight, knife, or other like device or combination.

Interior region 212 may be designed to receive or contain third distinct tool 214. Third distinct tool 214 is a tool accessory for multi-purpose tool 200 that may be securely attached to and removed from elongated member 202 via universal connector 204 and universal receiver 206. When connected to elongated member 202, third distinct tool 214 may be situated within interior region 212. In such an embodiment, the length of third distinct tool 214 may be less than or equal to the length of interior region 212 and have a radius less than or equal to the radius of interior region 212. Universal connector 204 and universal receiver 206 may be disengaged in order to remove third distinct tool 214 from within interior region 212. In such exemplary usage, universal connector 204 and universal receiver 206 may be disengaged to separate second distinct tool 210 from third distinct tool 214.

In the embodiment of the present invention depicted FIG. 2, third distinct tool 214 comprises a knife. However, in other embodiments of the present invention, third distinct tool 214 may comprise a screwdriver, scissors, pick, nail remover, shovel, or other like device or combination.

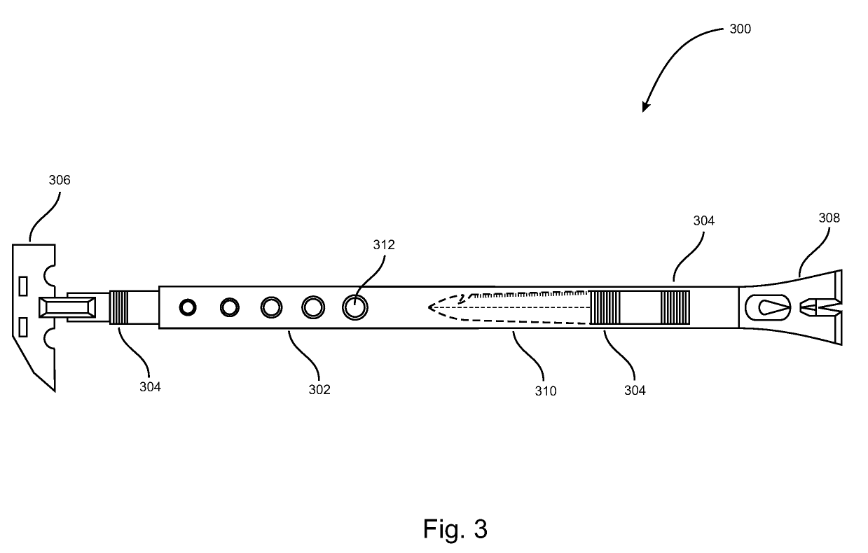

FIG. 3 illustrates a side view of a multi-purpose tool comprising four distinct tools. FIG. 3 shows multi-purpose tool 300, which comprises elongated member 302, universal connection 304, first distinct tool 306, second distinct tool 308, third distinct tool 310, and fourth distinct tool 312. Multi-purpose tool 300 is designed to provide the utility of a plurality of tools, but to also be comprised of a reduced weight and volume through the interchangeability of distinct tool attachments.

Elongated member 302 is the main body of multi-purpose tool 300. Elongated member 302 may be composed of a variety of materials, including wood, metals, alloys, plastics, or any other material that is sufficiently rigid so as to withstand normal wear and tear during use of multi-purpose tool 300. Elongated member 302 may be cylindrical or rectangular, such that a user may securely, but comfortably, grip elongated member 302 in use or transport of multi-purpose tool 300. In a preferred embodiment, elongated member 302 may be a cylindrical rod, with a length between two and three feet. However, the shape or dimensions of elongated member 302 should not be interpreted so as to limit the scope of the present invention.

Elongated member 302 may include an interior region for enclosing third distinct tool 310. In an exemplary embodiment of the present invention, the length of the interior region inside elongated member 302 may be equal to the length of third distinct tool 310. In another embodiment of the present invention, however, the length of the interior region may be longer than the length of third distinct tool 310.

Universal connection 304 comprises a universal connector and a universal receiver. Universal connector and universal receiver may be disengaged in order to disconnect distinct tools from elongated member 302.

First distinct tool 306 is a tool accessory for multi-purpose tool 300 that may be securely attached to and removed from elongated member 302 via a universal connector and universal receiver. In the embodiment depicted in FIG. 3, first distinct tool 306 may comprise a hammer and pick combination. However, in other embodiments of the present invention, first distinct tool 306 may comprise another tool such as a spike, shovel, nail remover, axe, crowbar, helmet counterweight, knife or other device or combination thereof.

Second distinct tool 308 is a tool accessory for multi-purpose tool 300 that may be securely attached to and removed from elongated member 302 via a universal connector and universal receiver. In this embodiment, second distinct tool 308 comprises a crowbar tool. However, in other embodiments of the present invention, second distinct tool 308 may comprise another tool such as a spike, hammer, pick, shovel, nail remover, axe, helmet counterweight, knife or other device or combination thereof.

Third distinct tool 310 is a tool accessory for multi-purpose tool 300 that may be securely attached to and removed from elongated member 302 via a universal connector and universal receiver. When connected to elongated member 302, third distinct tool 310 may be situated inside an interior region within elongated member 302. In the present embodiment, third distinct tool 310 comprises a knife. However, in other embodiments of the present invention, third distinct tool 310 may comprise a screwdriver, hook, scissors, pick, nail remover, shovel, or other like device or combination.

Fourth distinct tool 312 is a tool accessory for multi-purpose tool 300 located within elongated member 302. In the present embodiment, fourth distinct tool 312 comprises a plurality of lateral spaced wire cutters along the length of elongated member 302. In the present embodiment, fourth distinct tool 312 may not be removed from elongated member 302. In other embodiments of the present invention, however, fourth distinct tool 312 may be removed from elongated member 302, or may comprise another device.

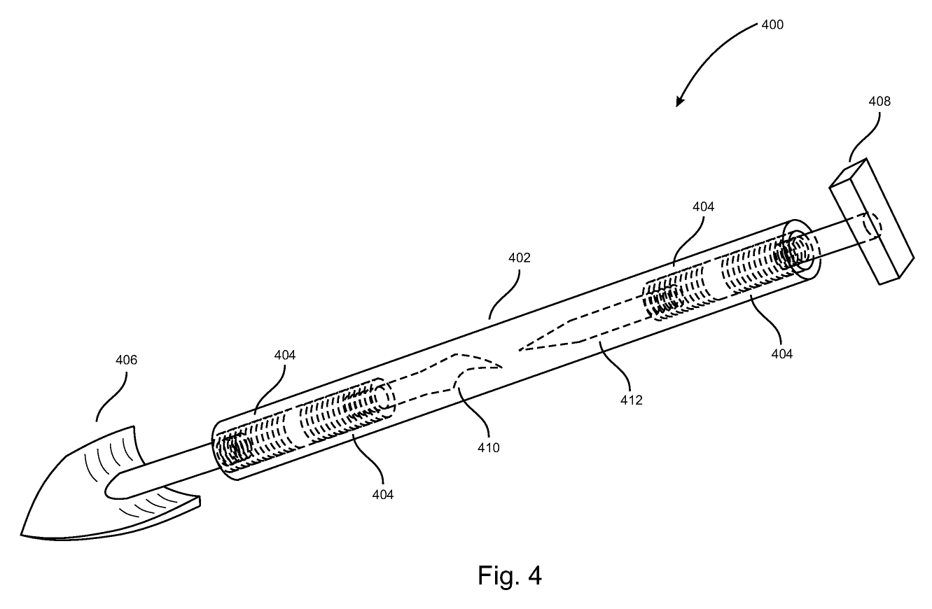

FIG. 4 illustrates a perspective view of a multi-purpose tool comprising four distinct tools. FIG. 4 shows multi-purpose tool 400, which comprises elongated member 402, universal connection 404, first distinct tool 406, second distinct tool 408, third distinct tool 410, and fourth distinct tool 412. Multi-purpose tool 400 is designed to provide the utility of a plurality of tools, but to also be comprised of a reduced weight and volume through the interchangeability of distinct tool attachments.

Elongated member 402 is the main body of multi-purpose tool 400. Elongated member 402 may be composed of a variety of materials, including wood, metals, alloys, plastics, or any other material that is sufficiently rigid so as to withstand normal wear and tear during use of multi-purpose tool 400. Elongated member 402 may be cylindrical or rectangular, such that a user may securely, but comfortably, grip elongated member 402 in use or transport of multi-purpose tool 400. In a preferred embodiment, elongated member 402 may be a cylindrical rod, with a length between two and three feet. However, the shape or dimensions of elongated member 402 should not be interpreted so as to limit the scope of the present invention.

Elongated member 402 may include a plurality of interior regions for the enclosure of distinct tools. In the present embodiment, elongated member 402 includes two interior regions for enclosing and removing third distinct tool 410 and fourth distinct tool 412. In other embodiments, however, multi-purpose tool 400 may include more than two interior regions for storage and removable of distinct tools. In an exemplary embodiment of the present invention, the total length of the interior regions inside elongated member 402 may be equal to the length of third distinct tool 410 and fourth distinct tool 412, respectively. In another embodiment of the present invention, the lengths of the interior regions within elongated member 402 may be longer than the lengths of third distinct tool 410 and fourth distinct tool 412, but shorter than the total length elongated member 402.

Universal connection 404 comprises a universal connector and a universal receiver. Universal connector and universal receiver may be engaged to securely attach a distinct tool to elongated member 402, and may be disengaged in remove a distinct tool from elongated member 402.

First distinct tool 406 is a tool accessory for multi-purpose tool 400 that may be securely attached to and removed from elongated member 402 via a universal connector and universal receiver. In the embodiment depicted in FIG. 4, first distinct tool 406 comprises a shovel. However, in other embodiments of the present invention, first distinct tool 406 may comprise another tool such as a spike, hammer, pick, nail remover, axe, crowbar, helmet counterweight, knife or other device or combination thereof.

Second distinct tool 408 is a tool accessory for multi-purpose tool 400 that may be securely attached to and removed from elongated member 402 via a universal connector and universal receiver. In this embodiment, second distinct tool 408 comprises a block tool. However, in other embodiments of the present invention, second distinct tool 408 may comprise another tool such as a spike, hammer, pick, shovel, nail remover, axe, crowbar, helmet counterweight, knife or other device or combination thereof.

Third distinct tool 410 is a tool accessory for multi-purpose tool 400 that may be securely attached to and removed from elongated member 402 via a universal connector and universal receiver. When connected to elongated member 402, third distinct tool 410 may be situated inside an interior region within elongated member 402. In the present embodiment, third distinct tool 410 comprises a hook. However, in other embodiments of the present invention, third distinct tool 410 may comprise a knife, screwdriver, scissors, pick, nail remover, shovel, or other like device or combination.

Fourth distinct tool 412 is a tool accessory for multi-purpose tool 400 that may be securely attached to and removed from elongated member 412 via a universal connector and universal receiver. When connected to elongated member 402, fourth distinct tool 412 may be situated inside an interior region within elongated member 402. In the present embodiment, fourth distinct tool 412 comprises a knife. However, in other embodiments of the present invention, fourth distinct tool 412 may comprise a hook, screwdriver, scissors, pick, nail remover, shovel, or other like device or combination.

A multi-purpose tool has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A multi-purpose tool, comprising:
an elongated member including a handle and a plurality of universal connectors, wherein each universal connector is adapted to securely attach to a plurality of distinct tools;
a first distinct tool including a first universal connector securely mated to one of the universal connectors of the elongated member; and
a second distinct tool including a second universal connector securely mated to another of the universal connectors of the elongated member.

2. The multi-purpose tool of claim 1, wherein the first distinct tool comprises a pick.

3. The multi-purpose tool of claim 1, wherein the first distinct tool comprises a hammer.

4. The multi-purpose tool of claim 1, wherein the first distinct tool comprises a nail remover.

5. The multi-purpose tool of claim 1, wherein the first distinct tool comprises a helmet counterweight.

6. The multi-purpose tool of claim 1, wherein the first distinct tool comprises a shovel.

7. The multi-purpose tool of claim 1, wherein the first distinct tool comprises an axe.

8. The multi-purpose tool of claim 1, wherein the first distinct tool comprises a spike.

9. The multi-purpose tool of claim 1, wherein the first distinct tool is situated at an end of the elongated member.

10. The multi-purpose tool of claim 9, wherein the second distinct tool is situated at an opposite end of the elongated member.

11. The multi-purpose tool of claim 2, wherein the second distinct tool comprises a spike.

12. The multi-purpose tool of claim 2, wherein the second distinct tool comprises a shovel.

13. The multi-purpose tool of claim 2, wherein the second distinct tool comprises a nail remover.

14. The multi-purpose tool of claim 1, wherein the elongated member is configured to include a third distinct tool.

15. The multi-purpose tool of claim 14, wherein the third distinct tool is configured to cut wire.

16. The multi-purpose tool of claim 14, wherein the third distinct tool is a knife situated longitudinally within the elongated member.

17. The multi-purpose tool of claim 14, wherein the third distinct tool is a screwdriver situated longitudinally within the elongated member.

18. The multi-purpose tool of claim 1, wherein the elongated member comprises a plurality of attachable and removable elongated portions.

19. The multi-purpose tool of claim 18, wherein an elongated portion comprises a third distinct tool.

20. The elongated member of claim 18, wherein the elongated portions may be coupled via a threaded screw mechanism.

21. The multi-purpose tool of claim 14, wherein the elongated member is configured to include a fourth distinct tool.

22. A multi-purpose tool comprising an elongated member including a handle and a plurality of universal connectors, wherein each universal connector is adapted to securely attach to a plurality of distinct tools.

23. The multi-purpose tool of claim 22, wherein the elongated member comprises a plurality of attachable and removable elongated portions.

24. The elongated member of claim 23, wherein each elongated portion comprises an internal tool.
